(19) United States
(12) Patent Application Publication
(10) Pub. No.: US 2006/0267379 A1
(43) Pub. Date: Nov. 30, 2006

(54) Movable panels for overhead frame structures

(76) Inventor: Leighton Johnson, Grove City, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/433,330

(22) Filed: May 12, 2006

Related U.S. Application Data
(60) Provisional application No. 60/680,847, filed on May 13, 2005.

(51) Int. Cl. B60J 7/00; B60K 1/00; B60K 37/00

(52) U.S. Cl. 296/190.08; 296/190.11; 180/65.1

(57) ABSTRACT

A vehicle includes an overhead framework having one or more members that form an enclosure for the vehicle. The frame members help define one or more major openings to the enclosure that are each at least partially covered by one or more panels. At least one of the panels is operatively retained by the frame members. The frame members operatively retain the one panel via one or more elements extending therefrom. The elements include lower portions and upper portions. The lower element portions, extending from framework members forming the sides of the vehicle enclosure, operatively function with the upper element portions, located in framework members forming the top of the vehicle enclosure. As such, the panel can be moved from an in-use position along the lower channel portions to a storage position along the upper channel portions, or vice versa. When the panel is in either an in-use position or a storage position, or conversely, when the panel is raised or lowered from one position to the other, the panel generally stays within the vehicle enclosure so as to not protrude from the vehicle. Further, when the panel is in either an in-use position or a storage position, or conversely, when the panel is raised or lowered, there is a limited amount of entry of the panel into the vehicle enclosure so as to not protrude into the operator's space.

The present application claims priority to provisions U.S. patent application filed May 13, 2005 and assigned Ser. No. 60/680,847, the entire disclosure of which is incorporated herein by reference.

### FIELD

The invention relates to overhead frame structures utilized on vehicles, and in particular, to panels disposed on the frame structures.

### BACKGROUND

Overhead frame structures are typically fabricated of various members assembled to form a framework. Such structures may be used on a vehicle for one or more reasons. The structures may be utilized to protect an operator from injury in the event of accidental upset or inadvertent rollover of the vehicle. Additionally, the structures may be used for mounting various accessories thereto. Further, the structures may be used as frameworks to mount enclosure elements thereto.

Enclosure elements that are often operatively coupled to the frame members involve panels. Such panels are used to generally cover openings in the framework in order to protect the operator from among other things, undesirable elements outside the vehicle. Such elements can vary based on the type of vehicle; however, on most vehicles, the panels are used to protect the operator from disagreeable weather elements, for example cold air, rain, wind, etc. By using the panels to cover the main openings of the framework, one can create a controlled environment within the vehicle for the operator to work comfortably for long hours on the job.

Quite often, when operating the vehicles, it may be the desire of the operator to open at least one of the panels. In vehicle designs where the front opening of the framework has been closed to the outside environment, a window may be located in another panel, e.g., at the rear of the vehicle, to enable air to flow into and ventilate the enclosure of the vehicle. However, it is often the desire of the operator to have an opening in other panels (e.g., the front panel) as well. This is desirable in order for the operator to speak freely with others outside the vehicle, or to let further airflow into the vehicle when the weather is pleasant outside the vehicle.

Designs have been used to allow for a door to exist on the front of the vehicle. Many introductory designs have been implemented using hinges connecting the door to the overhead framework of the vehicle. However, this design enabled the door to only be opened in order to let the operator enter and exit the vehicle, and was not meant for leaving the door open when the vehicle was in operation. If left open during operation of the vehicles, such doors would often prevent the full operation of the vehicle.

Current designs have tended to address these shortcomings with the creation of a panel that can be raised from the front framework of the enclosure and stored. Some designs allow for the panel to be positioned in a frontal position on the vehicle when in use, and conversely, in an upper position in the enclosure when not in use (in storage).

Even with these current designs, there have been shortcomings. Embodiments of the present invention are directed to overcoming, or at least reducing these shortcomings.

### SUMMARY

A vehicle includes an overhead framework having one or more members that form an enclosure for the vehicle. The frame members help define one or more major openings to the enclosure that are each at least partially covered by one or more panels. At least one of the panels is operatively retained by the frame members. The frame members operatively retain the one panel via one or more elements extending therefrom. The elements include lower portions and upper portions. The lower element portions, extending from framework members forming the sides of the vehicle enclosure, operatively function with the upper element portions, located in framework members forming the top of the vehicle enclosure. As such, the panel can be moved from an in-use position along the lower channel portions to a storage position along the upper channel portions, or vice versa. When the panel is in either an in-use position or a storage position, or conversely, when the panel is raised or lowered from one position to the other, the panel generally stays within the vehicle enclosure so as to not protrude from the vehicle. Further, when the panel is in either an in-use position or a storage position, or conversely, when the panel is raised or lowered, there is a limited amount of entry of the panel into the vehicle enclosure so as to not protrude into the operator's space.

### DESCRIPTION OF THE DRAWINGS

FIG. 1 is a side perspective view of a vehicle, illustrating an overhead frame structure in accordance with certain embodiments of the invention.

FIG. 2 is a cross sectional top view of the overhead frame structure of FIG. 1, taken along the lines of 2-2 of FIG. 1.

FIG. 3 is a perspective view of the overhead frame structure of FIG. 1 taken along the lines of 3-3 with movable panel in an in-use position.

FIG. 4 is a side view of the overhead frame structure of FIG. 1 taken along the lines of 4-4 with movable panel in an in-use position.

FIG. 5 is a perspective view of the overhead frame structure of FIG. 1 taken along the lines of 3-3 with movable panel in a storage position.

FIG. 6 is a side view of the overhead frame structure of FIG. 1 taken along the lines of 4-4 with movable panel in a storage position.

FIG. 7 is a perspective view of the overhead frame structure of FIG. 1 taken along the lines of 3-3 with movable panel in a position between in-use and storage positions.

FIG. 8 is a side view of the overhead frame structure of FIG. 1 taken along the lines of 4-4 with movable panel in a position between in-use and storage positions.

### DETAILED DESCRIPTION

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. For example, the invention is designed for use on construction vehicles; however, it may also be used on other vehicles such as golf carts, go-carts, all-terrain vehicles, utility vehicles, mowing equipment, construction equipment, agricultural equipment, and the like.

In many current designs of vehicles, a framework structure is used in forming an enclosure for the operator. The framework structure of many current designs is formed of a plurality of members. As mentioned above, the frame members in such designs help define one or more openings to the enclosure, and such openings are likewise at least covered by one or more panels. Some of these designs have also included mechanisms to enable at least one of the panels to be raised from an in-use position on the enclosure to a storage position on the enclosure. Such panels are typically located at the side of the framework generally in front of the operator, and can be raised to and stored proximate to an upper area of the enclosure, generally above the operator.

However, with these current designs, such panels often protrude outside the enclosure area, either when the panels are in the in-use or storage positions, or conversely, when the panels are moved between such positions. As such, the panels can interfere with the operation of the vehicle and/or catch on things outside of the enclosure, particularly when such panels are being moved from one position to another position. In addition, such panels can be found to be not aesthetically pleasing because of such protruding. As a solution to these and other shortcomings of the current designs, embodiments of the invention can be used.

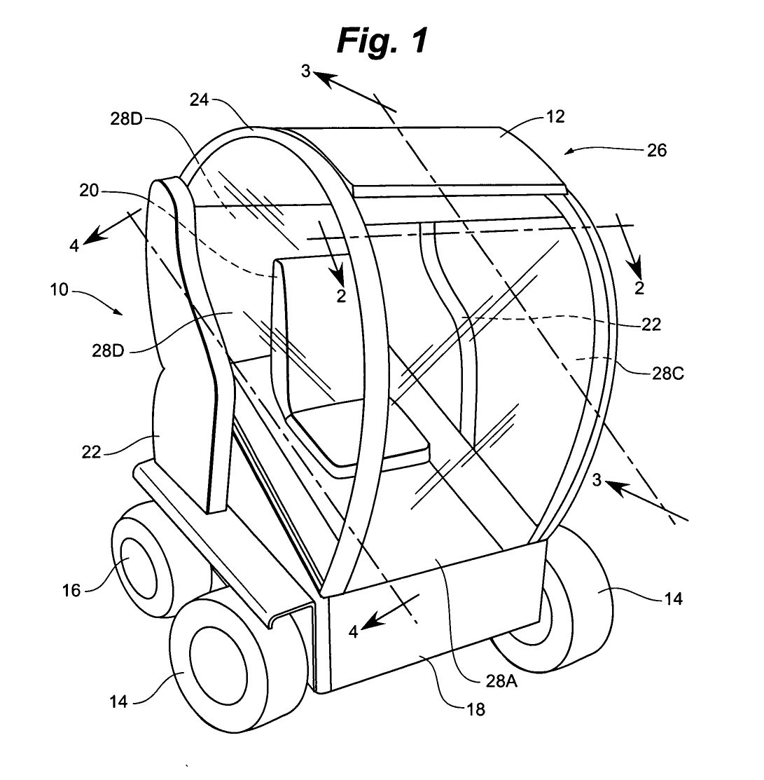

In certain embodiments of the invention, movable panels are provided for construction vehicles. Such vehicles can include but should not be limited to excavators, skidloaders, and backhoes. FIG. 1 shows a side perspective view of a construction vehicle 10, illustrating an overhead frame structure 12 in accordance with certain embodiments of the invention. The structure 12 may be utilized for a number of different functions as mentioned above. In turn, the structure 12 may generally be referenced as a rollover protective structure (ROPS), a falling object protective structure (FOPS), an accessory frame, a cab or enclosure frame, or a combination of one or more of such. While a construction vehicle is shown in FIG. 1, as mentioned herein, the type of vehicle 10 or equipment having such structure 12 should not be limited to such.

As shown, the vehicle 10 has front wheels 14, rear wheels 16 (only one of which is visibly shown), a base frame 18, an engine compartment (not visibly shown), a driver seat 20, side extensions 22 generally used for mounting the vehicle's working mechanisms (while such mechanisms are not shown, they can include but should not be limited to loaders, buckets, hoes, or other known working mechanisms), and the overhead frame structure 12. While not shown, it should be appreciated that the vehicle 10 may alternatively be equipped with other mechanisms (e.g., rubber tracks) instead of the wheels 14, 16 if desired. Generally, the structure 12 is operatively coupled to the frame 18 of the vehicle 10. In certain embodiments, as shown, the structure 12 is positioned above the driver seat 20 such that the structure 12 forms an enclosure 26, i.e., surrounding or containing such driver (not shown) when the vehicle 10 is occupied. A fastener assembly (not shown) is typically used to secure the structure 12 to the base frame 18.

Generally, as illustrated in FIG. 1, the structure 12 has one or more members 24 that form the vehicle enclosure 26. As shown, the frame members 24 help define one or more major openings to the vehicle enclosure 26. For applications in which the enclosure 26 is designed to isolate its interior (and the vehicle operator, not shown, within the enclosure 26) from the environment outside the enclosure 26, each major opening is at least partially covered by one or more panels. In certain embodiments, as shown, the one or more panels include a front panel 28A covering a front opening of the vehicle enclosure 26, side panels 28B and 28C covering side openings of the vehicle enclosure 26, and a back panel 28D covering a back opening of the vehicle enclosure 26.

In certain embodiments, each of the panels 28A-28D includes at least one sheet-like substrate. Each of the substrates can be flat, curved, or a combination of both. The substrates each typically have two generally-opposed major surfaces, which are generally parallel to each other. Typically, the panels 28A-28D can be made of a wide variety of materials. In certain embodiments, as shown in FIG. 1, the front panel 28A is a substrate formed of transparent material (e.g., a transparent pane). The transparent material can be made of glass, clear plastic, or the like, or a combination thereof. However, it should be appreciated that the front panel 28A may also include non-transparent material. For example, while not shown, a lower portion of the front panel 28A can be made of non-transparent material (e.g., metal, plastic, or the like), while an upper portion of the front panel 28A is made of transparent material. Another configuration, while not shown, could have the outer portions of the front panel 28A being of non-transparent material, while the inner portion of the front panel 28A is of transparent material.

Each of the other panels 28B, 28C, and 28D may also be formed of transparent material or a combination of materials as described above; however, it should be appreciated that one or more of the panels 28B, 28C, and 28D may also be formed entirely of non-transparent material. While embodiments described herein specifically reference the front panel 28A, it should be appreciated that the invention can also apply to one or more of the panels 28B, 28C, and 28D. As such, any one of the panels 28A-28D or any combination thereof may be used in employing the teachings herein. Further, while not shown, the panels 28A-28D should not be limited to solid continuous substrates. It should be appreciated that the panels 28A-28D may not only be compilations of different materials as exemplified above, but could also be patterned so as to have bores, slots, openings, and the like distributed over their surfaces and still be within the spirit of the invention.

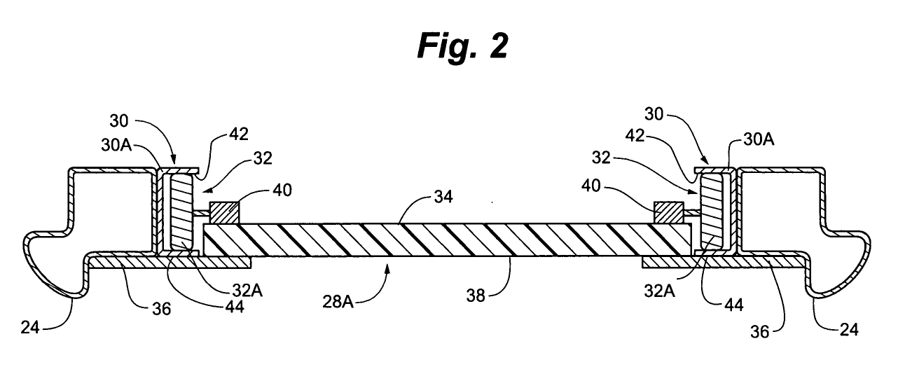

In certain embodiments of the invention, as illustrated in FIG. 2, the front panel 28A is operatively retained by the framework members 24 via one or more elements extending therefrom. While embodiments described herein refer to the elements as extending from the frame members 24, it is to be appreciated that the elements could just as well be formed to the frame members 24 to form a single body. Further, while certain elements are referenced and described herein, it should be appreciated that other similarly functioning elements (some of which are exemplified herein) could be alternatively used without departing from the spirit of the invention.

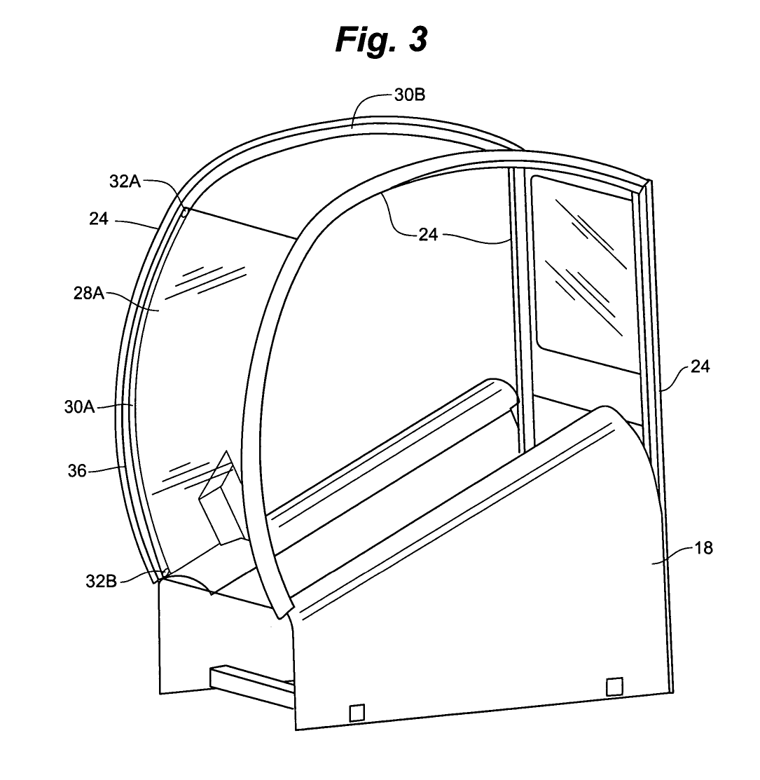

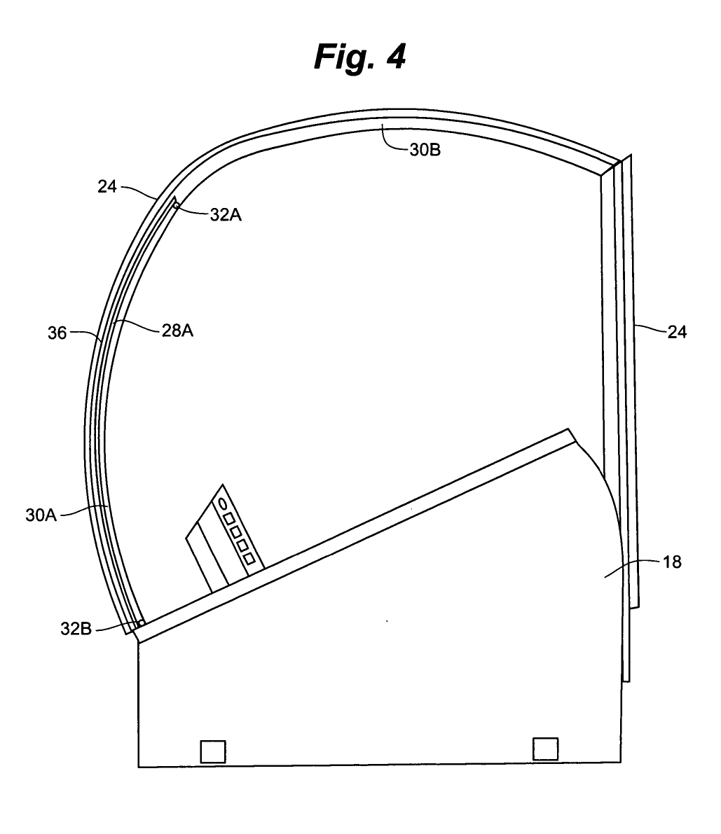

In certain embodiments, the elements extending from the framework members 24 include channels 30 that retain rollers 32 operatively coupled to an inner surface 34 of the panel 28A. As such, the channels 30 operatively support the panel 28A. The channels 30 are formed of aluminum or a similar robust material in order to adequately support the panel 28A. In certain embodiments, as shown in FIG. 2, the rollers 32 are operatively coupled to the panel 28A via linkages 40 that enable the rollers 32 to rotate when being moved within the channels 30. In certain embodiments, the panel 28A is operatively coupled to at least two sets of rollers 32, a first set of rollers 32A and a second set of rollers 32B (only the first set of rollers 32A is visibly shown in FIG. 2). As illustrated in FIGS. 3-4, the first set of rollers 32A is located near an upper portion of the panel 28A and the second set of rollers 32B is located near a lower portion of the panel 28A (in FIGS. 3-4, the rollers 32A, 32B are only visibly shown on one side of the panel 28A).

As described above, the channels 30 operatively support the inner surface 34 of the panel 28A via the rollers 32A, 32B. As such, the channels 30 enable the panel 28A to be supported in an in-use position on the vehicle enclosure 26. However, it is to be appreciated that the panel 28A could just as well be operatively coupled to mechanisms other than the rollers 32A, 32B. For example, while not shown, the panel 28A can be operatively coupled to other mechanisms, e.g., narrow extensions (not shown), which could also function with the channels 30 or alternatively, other conduits, e.g., tracks used for guiding the narrow extensions (not shown), to support the panel 28A in the in-use position.

As described above, the panel 28A is supported through its coupling to the rollers 32A, 32B (and their confinement within the channels 30). In certain embodiments, outer walls 36 extend from each of the frame members 24 across outer surfaces 44 of the channels 30. As such, outer portions of an outer surface 38 of the panel 28A come in contact with the outer walls 36. In certain embodiments, the outer walls 36 are a plastic or nibber material. As such, a seal can be generally provided between the panel 28A and outer walls 36 where the outer surface 38 of the panel 28A contacts the outer walls 36.

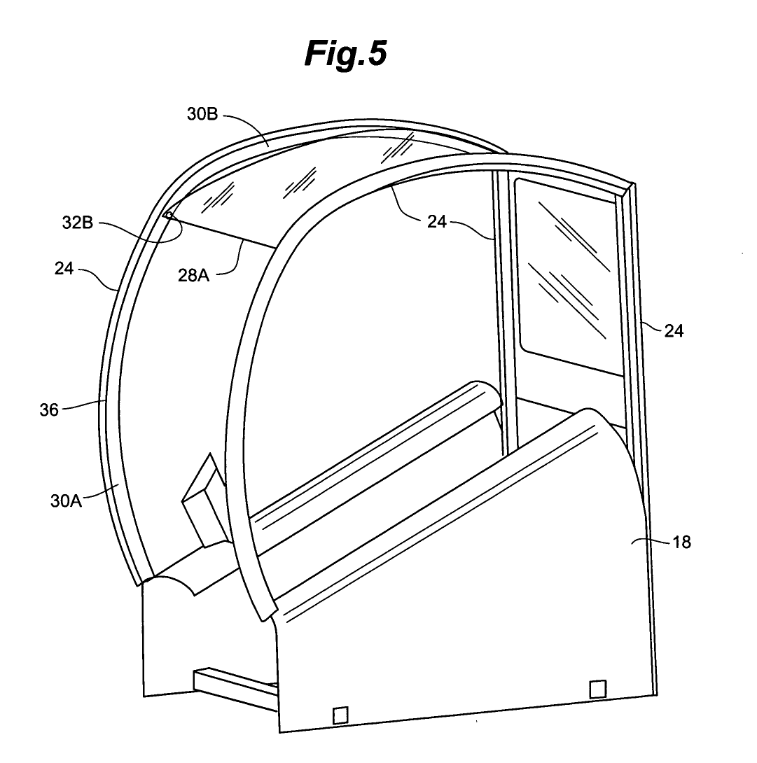

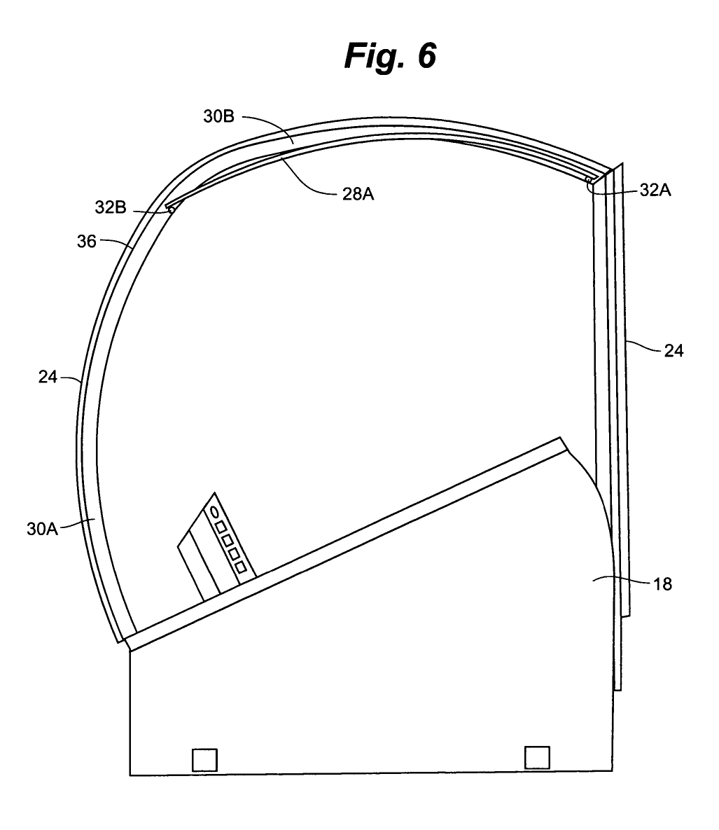

In certain embodiments, the channels 30 include lower portions 30A and upper portions 30B (only the lower channel portions 30A are visibly shown in FIG. 2). As illustrated in FIGS. 3-8, the lower channel portions 30A extend from the framework members 24 forming the sides of the vehicle enclosure 26, while the upper channel portions 30B extend from the framework members 24 forming the top of the vehicle enclosure 26. The lower channel portions 30A operatively function with the upper channel portions 30B, and in certain embodiments, upper ends of the lower channel portions 30A are linked with the front ends of the upper channel portions 30B so as to function as one body. In certain embodiments, such lower and upper channel portions 30A, 30B can be formed as a single piece. As illustrated in FIGS. 3 and 4, with respect to the lower channel portions 30A, each of the channel portions 30A retain the rollers 32A, 32B coupled to the inner surface 34 of the panel 28A when the panel 28A is in the in-use position. Similarly, as illustrated in FIGS. 5 and 6, with respect to the upper channel portions 30B, each of the upper channel portions 30B retain the rollers 32A, 32B when the panel 28A is in a storage position.

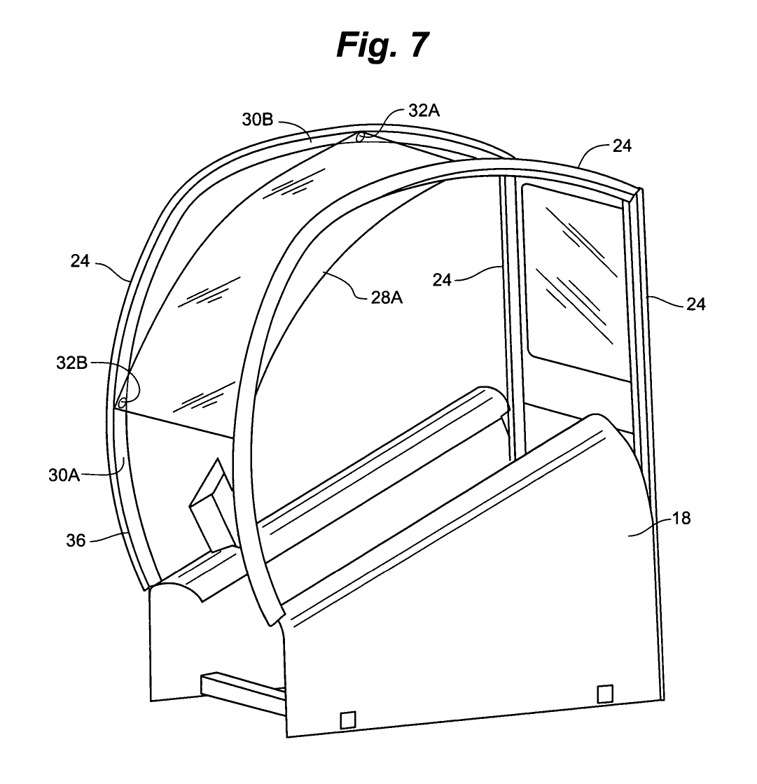

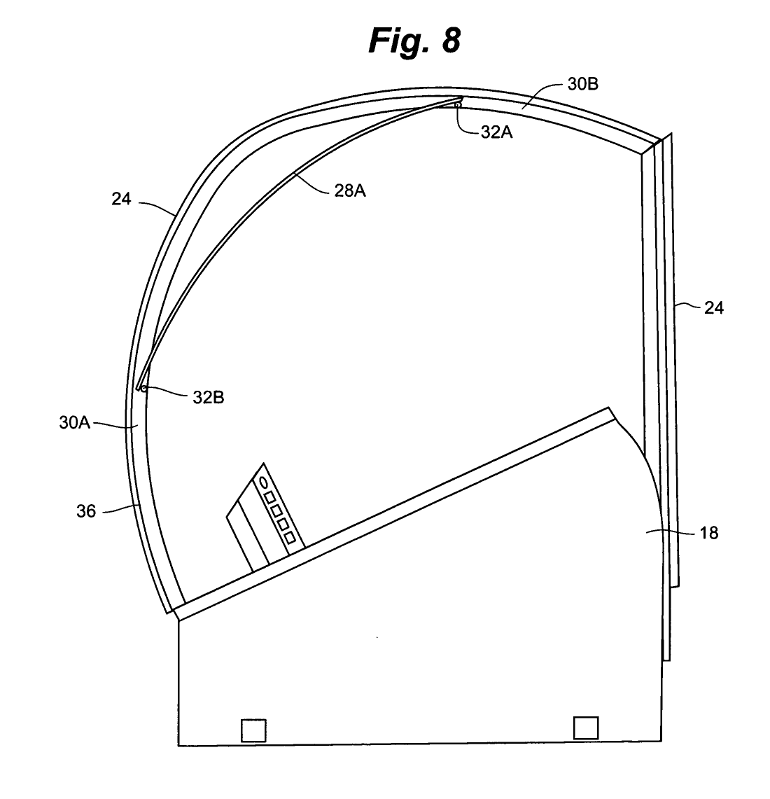

In use, the panel 28A can be moved from the in-use position (shown in FIGS. 1, 3, and 4) along the lower channel portions 30A to the storage position (shown in FIGS. 5 and 6) along the upper channel portions 30B, or vice versa. When the panel 28A is raised or lowered from one position to the other (shown in FIGS. 7 and 8), the panel 28A stays within the vehicle enclosure 26 so as to not protrude from the vehicle 10. Further, when the panel 28A is raised or lowered, there is a limited amount of entry of the panel 28A into the vehicle enclosure 26 so as to not protrude into the operator's space (as shown in FIGS. 7 and 8). As such, when the panel 28A is raised or lowered, the panel 28A is (i) self contained within the vehicle enclosure 26 so as to not interfere with vehicle operation or potentially catch on something outside the enclosure 26, (ii) not obtrusive to the operator within the enclosure 26, and (iii) aesthetically pleasing in its use because of its containment within the vehicle enclosure 26.

The movement of the rollers 32A and 32B within the channel portions 30A, 30B can be accomplished using a number of different methods depending on the roller type. For example, as illustrated in FIG. 2, if the rollers 32A, 32B (only rollers 32A are visibly shown in FIG. 2) are wheels having smooth, rounded outer surfaces, inner surfaces 42 of the channel portions 30A, 30B (only channel portions 30A are visibly shown in FIG. 2) contacting the rollers 32A, 32B can be made smooth as well. As such, the rollers 32A, 32B will roll freely across the inner surfaces 42 of the channels 30 when the panel 28A is raised or lowered. Conversely, in other embodiments, if the panel 28A is raised or lowered using mechanical methods, one well-known method could involve the rollers 32A, 32B being pinions which ride along racks formed on the inner surfaces 42 of the channel portions 30A, 30B. While not being further described herein, other such well-known mechanical methods could similarly be used without departing from the spirit of the invention.

As shown in FIGS. 3-6, in raising or lowering the panel 28A from one position (in-use or storage) to the other, the rollers 32A and 32B travel from the respective channel portions 30A or 30B to the other (in FIGS. 3-4, and 6, the rollers 32A, 32B are only visibly shown on one side of the panel 28A; in FIG. 5, the rollers 32A are not visibly shown, while only one of the rollers 32B is visibly shown on a side of the panel 28A). When the rollers 30A and 30B are each respectively in contact with upper channel portions 30B and lower channel portions 30A, as illustrated in FIGS. 7 and 8, the panel 28A is said to be in a position between the in-use and storage positions (in FIG. 7, the rollers 32A, 32B are only visibly shown on one side of the panel 28A; likewise, in FIG. 8, the rollers 32A, 32B are only visibly shown on one side of the panel 28A).

With reference to FIGS. 3 through 8, when the panel 28A is raised from the in-use position (shown in FIGS. 3 and 4) to the storage position (shown in FIGS. 5 and 6), the panel 30 must initially travel through the position shown in FIGS. 7 and 8. As such, the upper and lower rollers 32A and 32B of the panel 28A pass from the lower channel portions 30A to the upper channel portions 30B. As the panel 28A is initially raised, the upper rollers 32A of the panel 28A exit the lower channel portions 30A and enter the upper channel portions 30B. As the panel 28A is further raised, the lower rollers 32B exit the lower channel portions 30A and enter the upper channel portions 30B. Once both the rollers 32A and 32B are within the upper channel portions 30B such that the panel 28A is in the storage position, a mechanism may be used to retain the panel 28A in such position. It should be appreciated that a wide variety of mechanisms can be used for this purpose. In certain embodiments, the mechanism is a mechanical latch that can be adjusted so as to engage a bottom edge of the panel 28A proximate to the lower rollers 32B. In certain embodiments, the mechanism extends from one of the framework members 24 forming the top of the vehicle enclosure 26.

Conversely, when the panel 28A is lowered from the storage position (shown in FIGS. 5 and 6) to the in-use position (shown in FIGS. 3 and 4), the panel 28A must initially travel through the position shown in FIGS. 7 and 8. As such, the upper and lower rollers 32A and 32B of the panel 28A pass from the upper channel portions 30B to the lower channel portions 30A. As the panel 28A is initially lowered, the lower rollers 32B of the panel 28A exit the upper channel portions 30B and enter the lower channel portions 30A. As the panel 28A is further lowered, the upper rollers 32A exit the upper channel portions 30B and enter the lower channel portions 30A. Once both the rollers 32A and 32B are within the lower channel portions 30A such that the panel 28A is in the in-use position, a mechanism may be used to retain the panel 28A in such position. It should be appreciated that a wide variety of mechanisms can be used for this purpose. In certain embodiments, the mechanism is a mechanical latch that can be adjusted so as to engage a top edge of the panel 28A proximate to the upper rollers 32A. In certain embodiments, the mechanism extends from one of the framework members 24 forming a side of the vehicle enclosure 26.

When raised or lowered from one position to the other, the panel 28A generally stays within the vehicle enclosure 26 so as to not protrude from the vehicle 10. Further, in the area in which the panel 28A passes between the in-use and storage positions (as shown in FIGS. 7 and 8, there is a limited amount of entry of the panel 28A into the vehicle enclosure 26 so as to not protrude into the operator's space. As such, when the panel 28A is raised and lowered from one position to the other, the panel 28A is aesthetically pleasing to onlookers because it does not protrude outside the vehicle 10, while at the same time, is not obtrusive to the operator.

It will be appreciated the embodiments of the present invention can take many forms. The true essence and spirit of these embodiments of the invention are defined in the appended claims, and it is not intended the embodiment of the invention presented herein should limit the scope thereof.

What is claimed is:

1. A vehicle comprising:
a) a frame structure forming an enclosure for the vehicle, the enclosure comprised of a plurality of members, the plurality of members defining one or more openings to the enclosure; and
b) a panel sized to at least partially cover one of the one or more openings, the panel operatively supported by two of the plurality of members and operatively movable with respect to the two members so as to be positioned in either an in-use position or a storage position, the panel being within the enclosure when positioned in the in-use and storage positions as well as when moved between the in-use and storage positions, the panel at least partially covering the one opening when positioned in the in-use position and at least partially extending across an upper side of the enclosure when positioned in the storage position.

2. The vehicle of claim 1, wherein the vehicle comprises one of or a combination of one or more of a construction vehicle, a golf cart, a go-cart, an all-terrain vehicle, a utility vehicle, mowing equipment, construction equipment, and agricultural equipment.

3. The vehicle of claim 1, wherein the enclosure defines an operator space for the vehicle.

4. The vehicle of claim 1, wherein the panel comprises a sheet-like substrate having two generally-opposed major surfaces, and wherein the major surfaces are parallel to each other.

5. The vehicle of claim 1, wherein the panel is at least partially formed of a transparent material.

6. The vehicle of claim 1, wherein the panel is sized to cover the one opening, and wherein the panel covers the one opening when positioned in the in-use position.

7. The vehicle of claim 1, wherein the panel has a curvature, and wherein the panel curves around an operator of the vehicle when the panel is positioned in the in-use and storage positions as well as when the panel is moved between the in-use and storage positions.

8. The vehicle of claim 1, wherein the one opening comprises one of a front opening to the vehicle, a lateral opening to the vehicle, and a back opening to the vehicle.

9. The vehicle of claim 1, wherein each of the two members has a length extending from a first member end located proximate to a base frame of the vehicle to a second member end located on an upper side of the enclosure.

10. The vehicle of claim 1, wherein the two members are offset a distance from each other and extend in parallel with respect to each other.

11. The vehicle of claim 1, wherein the panel includes two opposing edges that extend in parallel with respect to each other across a length of the panel, wherein each of the two opposing edges are at least partially aligned with the two members when the panel is positioned in the in-use and storage positions as well as when the panel is moved between the in-use and storage positions, and wherein such alignment limits entry of the panel into an operator space of the vehicle.

12. The vehicle of claim 1, wherein each of the two members has a curvature, and wherein the two members are positioned so as to curve around an operator of the vehicle.

13. The vehicle of claim 1, wherein each of the two members has a receiving element, and wherein the receiving elements are adapted to support the panel within the enclosure when the panel is positioned in the in-use and storage positions as well as when the panel is moved between the in-use and storage positions.

14. The vehicle of claim 13, wherein each receiving element comprises a channel.

15. The vehicle of claim 13, wherein each of the receiving elements extend along a length defined with respect to the two members, and wherein the length is a distance along the two members measured from a first end of one of the two members located proximate to a base frame of the vehicle to a second end of the one member located on an upper side of the enclosure.

16. The vehicle of claim 13, wherein each receiving element includes a lower portion and an upper portion.

17. The vehicle of claim 16, wherein each receiving element lower portion extends from a distinct area on the enclosure proximate to the base frame of the vehicle to an upper side of the enclosure, and wherein each receiving element upper portion extends across the upper side of the enclosure.

18. The vehicle of claim 16, wherein the receiving element lower and upper portions for each of the two members are formed as a single piece.

19. The vehicle of claim 13, wherein the receiving elements of the two members are each oriented toward each other.

20. The vehicle of claim 13, wherein the panel includes two opposing edges that extend in parallel with respect to each other across a length of the panel, and wherein each of the opposing edges has a plurality of edge segments that are positioned between the two members both when the panel is positioned in the in-use and storage positions as well as when the panel is moved between the in-use and storage positions.

21. The vehicle of claim 20, wherein the panel includes a plurality of mechanisms, wherein one of the mechanisms extends from each of the edge segments, and wherein the panel is operatively supported by and movable with respect to the two members via respective insertion of the mechanisms within the receiving elements.

22. The vehicle of claim 21, wherein the mechanisms each comprise a roller.

23. The vehicle of claim 21, wherein the mechanisms are each operatively coupled to the segments via linkages.

24. The vehicle of claim 1, wherein the two members each include a front wall, and wherein each front wall at least partially extends a certain distance across the one opening.

25. The vehicle of claim 24, wherein two opposing edges of the panel each at least partially come in contact respectively with one of the front walls when the panel is positioned in the in-use position, and wherein the contact forms a seal between outer surfaces of the opposing edges of the panel and the walls.

26. A vehicle comprising:
a) a frame structure forming an enclosure for the vehicle, the enclosure comprised of a plurality of members, the plurality of members defining one or more openings to the enclosure; and
b) a panel sized to at least partially cover one of the one or more openings, the panel operatively supported by two of the plurality of members and operatively movable with respect to the two members so as to be positioned in either an in-use position or a storage position, the panel and the two members having curvatures, the panel movable with respect to the two members so as to curve around an operator of the vehicle when positioned in the in-use and storage positions as well as when moved between the in-use and storage positions.

27. The vehicle of claim 26, wherein the panel at least partially covers the one opening when positioned in the in-use position and at least partially extends across an upper side of the enclosure when positioned in the storage position.

28. The vehicle of claim 26, wherein the panel includes two opposing edges that extend in parallel with respect to each other across a length of the panel, wherein each of the two opposing edges are at least partially aligned with the two members when the panel is positioned in the in-use and storage positions as well as when the panel is moved between the in-use and storage positions, and wherein such alignment limits entry of the panel into an operator space of the vehicle.

29. The vehicle of claim 26, wherein the two members are offset a distance from each other and extend at least partially across the enclosure, and wherein the two members are in parallel with respect to each other.

30. The vehicle of claim 26, wherein the panel is within the enclosure when the panel is positioned in the in-use and storage positions as well as when the panel is moved between the in-use and storage positions

31. The vehicle of claim 30, wherein each of the two members has a receiving element, and wherein the receiving elements are adapted to support the panel within the enclosure when the panel is positioned in the in-use and storage positions as well as when the panel is moved between the in-use and storage positions.

32. The vehicle of claim 31, wherein the panel includes two opposing edges that extend in parallel with respect to each other across a length of the panel, each of the opposing edges having a plurality of edge segments that are positioned between the two members both when the panel is positioned in the in-use and storage positions as well as when the panel is moved between the in-use and storage positions.

33. The vehicle of claim 32, wherein the panel includes a plurality of mechanisms, wherein one of the mechanisms extends from each of the edge segments, and wherein the panel is operatively supported by and movable with respect to the two members via respective insertion of the mechanisms within the receiving elements.
